(19) United States
(12) Patent Application Publication
(10) Pub. No.: US 2026/0194802 A1
(43) Pub. Date: Jul. 9, 2026

(54) AUTO-FOCUS METHOD FOR PROJECTOR, PROJECTOR, AND NON-TRANSITORY COMPUTER-READABLE STORAGE MEDIUM

(71) Applicant: Anker Innovations Technology Co., Ltd., CHANGSHA (CN)

(72) Inventor: Zhenzhong SHI, SHENZHEN (CN)

(21) Appl. No.: 19/544,398

(22) Filed: Feb. 19, 2026

Related U.S. Application Data
(63) Continuation of application No. PCT/CN2022/113916, filed on Aug. 22, 2022.

(30) Foreign Application Priority Data
Aug. 30, 2021 (CN) 202111004062.6

(51) Int. Cl. G03B 21/53; G01S 13/08

(52) U.S. Cl. CPC G03B 21/53; G01S 13/08

(57) ABSTRACT

An auto-focus method for a projector, a projector and a non-transitory computer-readable storage medium are provided. The auto-focus method includes: calculating a projection distance based on measurement data from a distance measuring component of the projector; calculating a size of an image projected by the projector based on the projection distance according to a throw ratio of a lens module of the projector; calculating a driving parameter of a focus motor based on the size of the image according to characteristics of the focus motor and the lens module of the projector; and controlling the focus motor to drive the lens module to move based on the driving parameter of the focus motor, and achieving auto-focus.

### CROSS REFERENCE TO RELATED APPLICATIONS

The present disclosure is a continuation of International Patent Application No. PCT/CN2022/113916, filed on August 22, 2022, which claims priority to Chinese Patent Application No. 202111004062.6, filed on August 30, 2021, both of which are herein incorporated by reference in their entireties.

### TECHNICAL FIELD

The present disclosure relates to the technical field of projectors, and in particular to an auto-focus method for a projector, a projector and a non-transitory computer-readable storage medium.

### BACKGROUND

Currently, an auto-focus method for a projector is similar to a “contrast-detection” focus method used in a digital camera. During the entire focus process, a focus motor is required to continuously drive a lens to move to find a contrast point in an image until the image becomes clear. Therefore, the current auto-focus process for the projector is very slow and requires a focus image, which interrupts the entire viewing experience.

Thus, a new auto-focus method for a projector is needed to solve the above problems.

### SUMMARY

According to an aspect of the present disclosure, an auto-focus method for a projector is provided and includes: calculating a projection distance based on measurement data from a distance measuring component of the projector; calculating a size of an image projected by the projector based on the projection distance according to a throw ratio of a lens module of the projector; calculating a driving parameter of a focus motor based on the size of the image according to characteristics of the focus motor and the lens module of the projector; and controlling the focus motor to drive the lens module to move based on the driving parameter of the focus motor, and achieving auto-focus.

In some embodiments, calculating the size of the image projected by the projector based on the projection distance according to the throw ratio of the lens module of the projector, includes: dividing the projection distance by the throw ratio of the lens module, and obtaining a lateral size of the image projected by the projector; calculating a longitudinal size of the image projected by the projector based on an aspect ratio of the image projected by the projector and the lateral size; and calculating a diagonal size of the image projected by the projector based on the lateral size and the longitudinal size, and taking the diagonal size as the size of the image.

In some embodiments, calculating the longitudinal size of the image projected by the projector based on the aspect ratio of the image projected by the projector and the lateral size, includes: calculating a product of the lateral size and the aspect ratio, calculating a reciprocal of the product, and obtaining the longitudinal size of the image projected by the projector.

In some embodiments, calculating the diagonal size of the image projected by the projector based on the lateral size and the longitudinal size, includes: calculating a square root of a sum of squares of the lateral size and the longitudinal size, and obtaining the diagonal size of the image projected by the projector.

In some embodiments, calculating the driving parameter of the focus motor based on the size of the image according to the characteristics of the focus motor and the lens module of the projector, includes: calculating the driving parameter of the focus motor based on the size of the image according to a total travel step of the focus motor, a total degree of the lens module, and a corresponding relationship between a degree of the lens module and the size of the image.

In some embodiments, calculating the driving parameter of the focus motor based on the size of the image according to the total travel step of the focus motor, the total degree of the lens module, and the corresponding relationship between the degree of the lens module and the size of the image, includes: calculating a step required for the focus motor to rotate per one degree conversion of the lens module according to the total travel step of the focus motor and the total degree of the lens module; determining an angle that the lens module is required to convert based on the size of the image according to the corresponding relationship between the degree of the lens module and the size of the image; and calculating a total required travel step of the focus motor based on the step required for the focus motor to rotate per one degree conversion of the lens module and the angle that the lens module is required to convert, and taking the total required travel step of the focus motor as the driving parameter.

In some embodiments, the distance measuring component includes a time-of-flight sensor module.

In some embodiments, the distance measuring component includes a first time-of-flight sensor and a second time-of-flight sensor. The first time-of-flight sensor is configured to output a first distance, and the first distance is a distance from a position of the first time-of-flight sensor to a first position on a projection screen; the second time-of-flight sensor is configured to output a second distance, and the second distance is a distance from a position of the second time-of-flight sensor to a second position on the projection screen; the second distance is greater than the first distance, the second distance minus the first distance equals a third distance, the third distance is a distance from a third position to the second position, and the third position is a position between the second time-of-flight sensor and the second position; calculating the projection distance based on the measurement data from the distance measuring component of the projector, includes: calculating a distance from the first position to the third position based on the first distance, an angle of the second time-of-flight sensor, and a distance between the first time-of-flight sensor and the second time-of-flight sensor, and taking the distance from the first position to the third position as a fourth distance; calculating a distance from the first position to the second position based on the third distance, the fourth distance, and the angle, and taking the distance from the first position to the second position as a fifth distance; calculating an included angle between a straight line where the fourth distance is located and a straight line where the fifth distance is located based on the third distance, the fourth distance, the fifth distance, and the angle; and calculating the projection distance from the projector to the projection screen based on the first distance, the angle, the included angle, and the distance between the first time-of-flight sensor and the second time-of-flight sensor.

According to another aspect of the present disclosure, a projector is provided and includes: a distance measuring component, a memory, a processor, a focus motor and a lens module. The distance measuring component is configured to output distance measurement data related to a distance between the projector and a projection screen; the memory is configured to store an executable program; the processor is configured to execute the program stored in the memory to cause the processor to perform the following operations: calculating a projection distance based on the distance measurement data; calculating a size of an image projected by the projector based on the projection distance according to a throw ratio of the lens module; calculating a driving parameter of the focus motor based on the size of the image according to characteristics of the focus motor and the lens module; and controlling the focus motor to drive the lens module to move based on the driving parameter of the focus motor, and achieving auto-focus.

In some embodiments, the distance measuring component includes a time-of-flight sensor module.

In some embodiments, the distance measuring component includes a first time-of-flight sensor and a second time-of-flight sensor. The first time-of-flight sensor is configured to output a first distance, and the first distance is a distance from a position of the first time-of-flight sensor to a first position on the projection screen; the second time-of-flight sensor is configured to output a second distance, and the second distance is a distance from a position of the second time-of-flight sensor to a second position on the projection screen; the second distance is greater than the first distance, the second distance minus the first distance equals a third distance, the third distance is a distance from a third position to the second position, and the third position is a position between the second time-of-flight sensor and the second position; calculating, by the processor, the projection distance based on the distance measurement data, includes: calculating a distance from the first position to the third position based on the first distance, an angle of the second time-of-flight sensor, and a distance between the first time-of-flight sensor and the second time-of-flight sensor, and taking the distance from the first position to the third position as a fourth distance; calculating a distance from the first position to the second position based on the third distance, the fourth distance, and the angle, and taking the distance from the first position to the second position as a fifth distance; calculating an included angle between a straight line where the fourth distance is located and a straight line where the fifth distance is located based on the third distance, the fourth distance, the fifth distance, and the angle; and calculating the projection distance from the projector to the projection screen based on the first distance, the angle, the included angle, and the distance between the first time-of-flight sensor and the second time-of-flight sensor.

In some embodiments, calculating, by the processor, the size of the image projected by the projector based on the projection distance according to the throw ratio of the lens module, includes: dividing the projection distance by the throw ratio of the lens module, and obtaining a lateral size of the image projected by the projector; calculating a longitudinal size of the image projected by the projector based on an aspect ratio of the image projected by the projector and the lateral size; and calculating a diagonal size of the image projected by the projector based on the lateral size and the longitudinal size, and taking the diagonal size as the size of the image.

In some embodiments, calculating, by the processor, the longitudinal size of the image projected by the projector based on the aspect ratio of the image projected by the projector and the lateral size, includes: calculating a product of the lateral size and the aspect ratio, calculating a reciprocal of the product, and obtaining the longitudinal size of the image projected by the projector.

In some embodiments, calculating, by the processor, the diagonal size of the image projected by the projector based on the lateral size and the longitudinal size, includes: calculating a square root of a sum of squares of the lateral size and the longitudinal size, and obtaining the diagonal size of the image projected by the projector.

In some embodiments, calculating, by the processor, the driving parameter of the focus motor based on the size of the image according to the characteristics of the focus motor and the lens module, includes: calculating the driving parameter of the focus motor based on the size of the image according to a total travel step of the focus motor, a total degree of the lens module, and a corresponding relationship between a degree of the lens module and the size of the image.

In some embodiments, calculating, by the processor, the driving parameter of the focus motor based on the size of the image according to the total travel step of the focus motor, the total degree of the lens module, and the corresponding relationship between the degree of the lens module and the size of the image, includes: calculating a step required for the focus motor to rotate per one degree conversion of the lens module according to the total travel step of the focus motor and the total degree of the lens module; determining an angle that the lens module is required to convert based on the size of the image according to the corresponding relationship between the degree of the lens module and the size of the image; and calculating a total required travel step of the focus motor based on the step required for the focus motor to rotate per one degree conversion of the lens module and the angle that the lens module is required to convert, and taking the total required travel step of the focus motor as the driving parameter.

According to still another aspect of the present disclosure, a non-transitory computer-readable storage medium is provided and store a program instruction. The program instruction is configured to enable a processor to perform an auto-focus method for a projector; the auto-focus method includes: calculating a projection distance based on measurement data from a distance measuring component of the projector; calculating a size of an image projected by the projector based on the projection distance according to a throw ratio of a lens module of the projector; calculating a driving parameter of a focus motor based on the size of the image according to characteristics of the focus motor and the lens module of the projector; and controlling the focus motor to drive the lens module to move based on the driving parameter of the focus motor, and achieving auto-focus.

In some embodiments, calculating the size of the image projected by the projector based on the projection distance according to the throw ratio of the lens module of the projector, includes: dividing the projection distance by the throw ratio of the lens module, and obtaining a lateral size of the image projected by the projector; calculating a longitudinal size of the image projected by the projector based on an aspect ratio of the image projected by the projector and the lateral size; and calculating a diagonal size of the image projected by the projector based on the lateral size and the longitudinal size, and taking the diagonal size as the size of the image.

In some embodiments, calculating the longitudinal size of the image projected by the projector based on the aspect ratio of the image projected by the projector and the lateral size, includes: calculating a product of the lateral size and the aspect ratio, calculating a reciprocal of the product, and obtaining the longitudinal size of the image projected by the projector.

In some embodiments, calculating the diagonal size of the image projected by the projector based on the lateral size and the longitudinal size, includes: calculating a square root of a sum of squares of the lateral size and the longitudinal size, and obtaining the diagonal size of the image projected by the projector.

### BRIEF DESCRIPTION OF THE DRAWINGS

The above and other objectives, features, and technical effects of the present disclosure will become more apparent through a more detailed description of some embodiments of the present disclosure with reference to the accompanying drawings. The drawings are intended to provide a further understanding of some embodiments of the present disclosure and constitute a part of the specification. The drawings are used together with some embodiments of the present disclosure to explain the present disclosure and do not constitute a limitation on the present disclosure. In the drawings, the same reference numerals represent the same components or operations.

FIG. 1 shows a schematic flowchart of an auto-focus method for a projector according to some embodiments of the present disclosure.

FIG. 2 shows a schematic diagram of an example of obtaining an image size in an auto-focus method for a projector according to some embodiments of the present disclosure.

FIG. 3 shows a schematic diagram of an example of a corresponding relationship between a degrees of a lens module and an image size in an auto-focus method for a projector according to some embodiments of the present disclosure.

FIG. 4 shows a schematic block diagram of a projector according to some embodiments of the present disclosure.

### DETAILED DESCRIPTION

To make the objectives, technical solutions, and technical effects of the present disclosure more apparent, the exemplary embodiments of the present disclosure will be described in detail below with reference to the accompanying drawings. Obviously, the described embodiments are only some embodiments of the present disclosure, not all embodiments. It should be understood that the present disclosure is not limited by the exemplary embodiments described herein. Based on the embodiments of the present disclosure described in the present disclosure, all other embodiments obtained by those skilled in the art without creative work shall fall within the scope of the present disclosure.

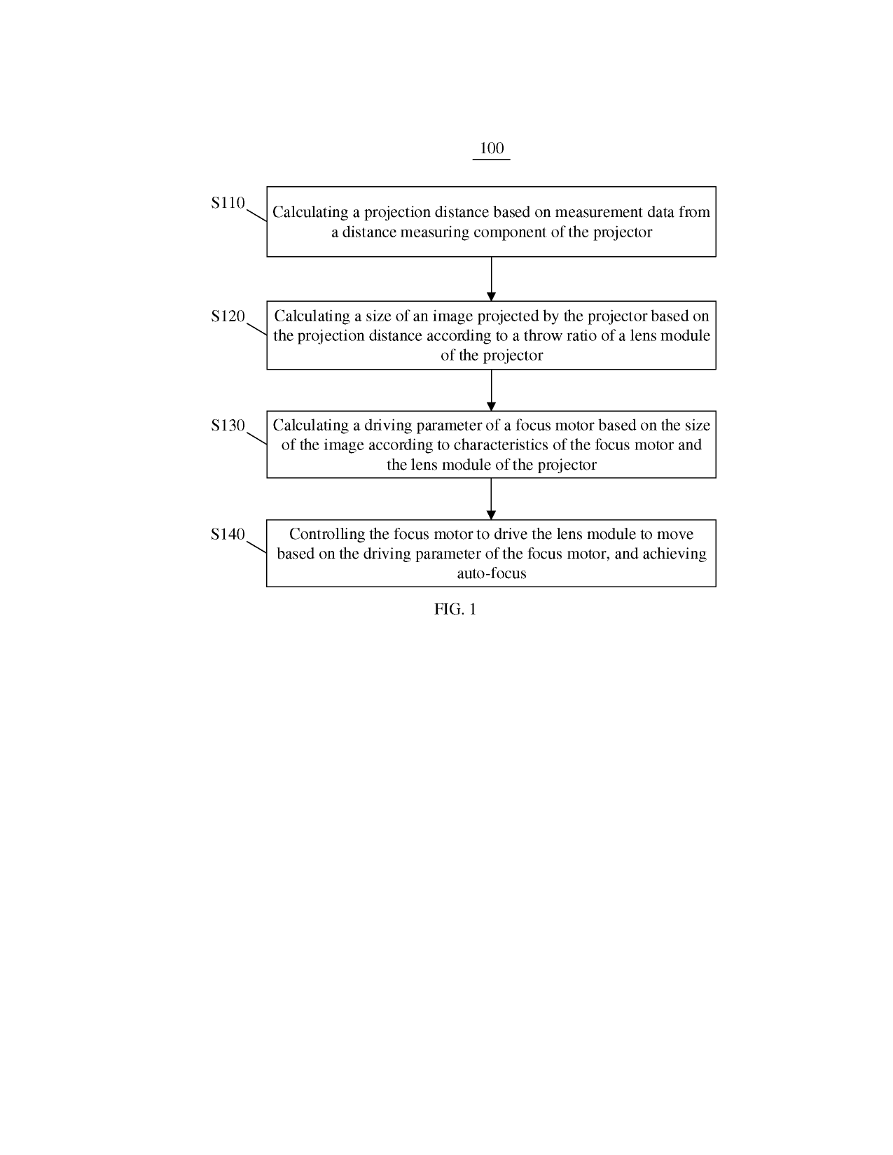

First, FIG. 1 illustrates an auto-focus method 100 for a projector according to some embodiments of the present disclosure. As shown in FIG. 1, the auto-focus method 100 for the projector may include the following operations:

An operation S110 may include: calculating a projection distance based on measurement data from a distance measuring component of the projector.

An operation S120 may include, calculating a size of an image projected by the projector based on the projection distance according to a throw ratio of a lens module of the projector.

An operation S130 may include: calculating a driving parameter of a focus motor based on the size of the image according to characteristics of the focus motor and the lens module of the projector.

An operation S140 may include: controlling the focus motor to drive the lens module to move based on the driving parameter of the focus motor to achieve auto-focus.

In some embodiments of the present disclosure, based on the distance measurement data from the distance measuring component (such as a single time-of-flight (TOF) module capable of quickly measuring distance) of the projector, the projection distance between the projector and the projection screen (such as a projection screen) may be calculated. Combined with the throw ratio of the lens module of the projector, the size of the image projected by the projector onto the projection screen may be calculated. Based on this size and in combination with the characteristics (mainly involving the total travel step of the focus motor, the total degree of the lens module, and the corresponding relationship between the degrees of the lens module and the size of the image) of the focus motor and the lens module, the driving parameter of the focus motor may be calculated. According to this driving parameter, the lens module may be controlled to move, thereby quickly achieving auto-focus. Moreover, since there is no need to pop up a focus image via a camera, the viewing process is not interrupted, thereby improving user experience.

In some embodiments of the present disclosure, in a case where the distance measuring component of the projector includes a first time-of-flight sensor and a second time-of-flight sensor, the first time-of-flight sensor may be configured to output a first distance, the first distance may be a distance from a position of the first time-of-flight sensor to a first position on the projection screen, the second time-of-flight sensor may be configured to output a second distance, and the second distance is a distance from a position of the second time-of-flight sensor to a second position on the projection screen. The second distance may be greater than the first distance, the second distance minus the first distance equals a third distance, the third distance may be a distance from a third position to the second position, and the third position may be a position between the second time-of-flight sensor and the second position. Based on this, the calculating a projection distance based on measurement data from a distance measuring component of the projector in the operation S110 may include: calculating a distance from the first position to the third position based on the first distance, an angle of the second time-of-flight sensor, and a distance between the first time-of-flight sensor and the second time-of-flight sensor, and taking the distance from the first position to the third position as a fourth distance; calculating a distance from the first position to the second position based on the third distance, the fourth distance, and the angle, and taking the distance from the first position to the second position as a fifth distance; calculating an included angle between a straight line where the fourth distance is located and a straight line where the fifth distance is located based on the third distance, the fourth distance, the fifth distance, and the angle; and calculating the projection distance from the projector to the projection screen based on the first distance, the angle, the included angle, and the distance between the first time-of-flight sensor and the second time-of-flight sensor.

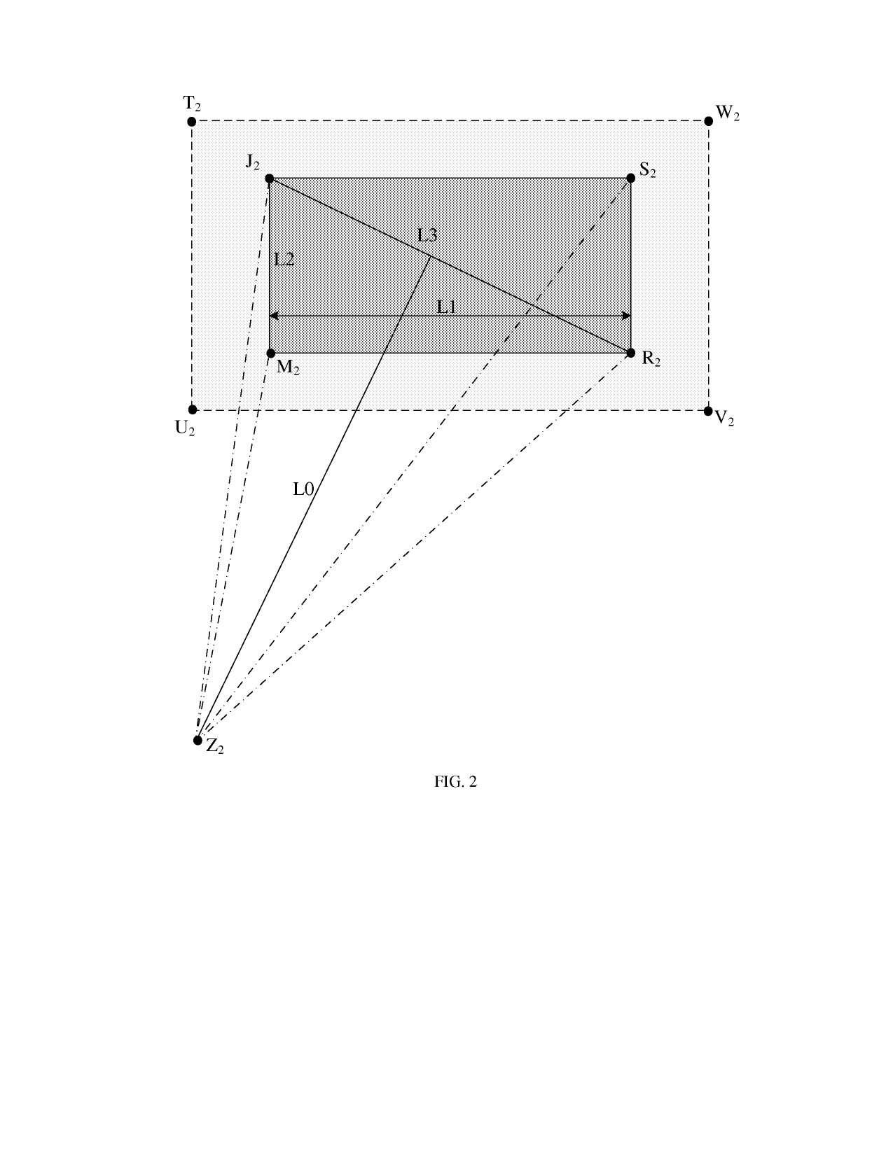

In some embodiments of the present disclosure, the calculating a size of an image projected by the projector based on the projection distance according to a throw ratio of a lens module of the projector in the operation S120 may include: dividing the projection distance by the throw ratio of the lens module, and obtaining a lateral size of the image projected by the projector; calculating a longitudinal size of the image projected by the projector based on an aspect ratio of the image projected by the projector and the lateral size; and calculating a diagonal size of the image projected by the projector based on the lateral size and the longitudinal size, and taking the diagonal size as the size of the image. The calculating a longitudinal size of the image projected by the projector based on an aspect ratio of the image projected by the projector and the lateral size may include: calculating a product of the lateral size and the aspect ratio, calculating a reciprocal of the product, and obtaining the longitudinal size of the image projected by the projector. The calculating a diagonal size of the image projected by the projector based on the lateral size and the longitudinal size may include: calculating a square root of a sum of squares of the lateral size and the longitudinal size, and obtaining the diagonal size of the image projected by the projector. The following description is made in conjunction with FIG. 2.

FIG. 2 shows a schematic diagram of an example of obtaining the image size in the auto-focus method for a projector according to some embodiments of the present disclosure. As shown in FIG. 2, Z₂ is a placement position of the projector, and an image actually projected onto a projection screen T₂W₂V₂U₂ is J₂S₂R₂M₂. The projection distance measured by the distance measuring component of the projector is L0, which is a vertical distance from the placement position Z₂ to the projection screen (such as a center of the projection screen). Given that the throw ratio of the lens module of the projector is R (e.g., 1.27), a lateral size L1 of the projected image J₂S₂R₂M₂ may be calculated based on this throw ratio R and the projection distance L0. Specifically, L1 = L0/R. Next, a longitudinal size L2 of the projected image J₂S₂R₂M₂ may be calculated based on the lateral size L1 of the projected image J₂S₂R₂M₂ and a known aspect ratio S (e.g., 16/9) of the projected image. Specifically, L2 = 1/S * L1. Finally, a diagonal size L3 of the projected image J₂S₂R₂M₂ may be calculated based on the lateral size L1 and the longitudinal size L2 of the projected image J₂S₂R₂M₂. Specifically, L3 = √(L1² + L2²). This diagonal size L3 may serve as a size of the projected image J₂S₂R₂M₂.

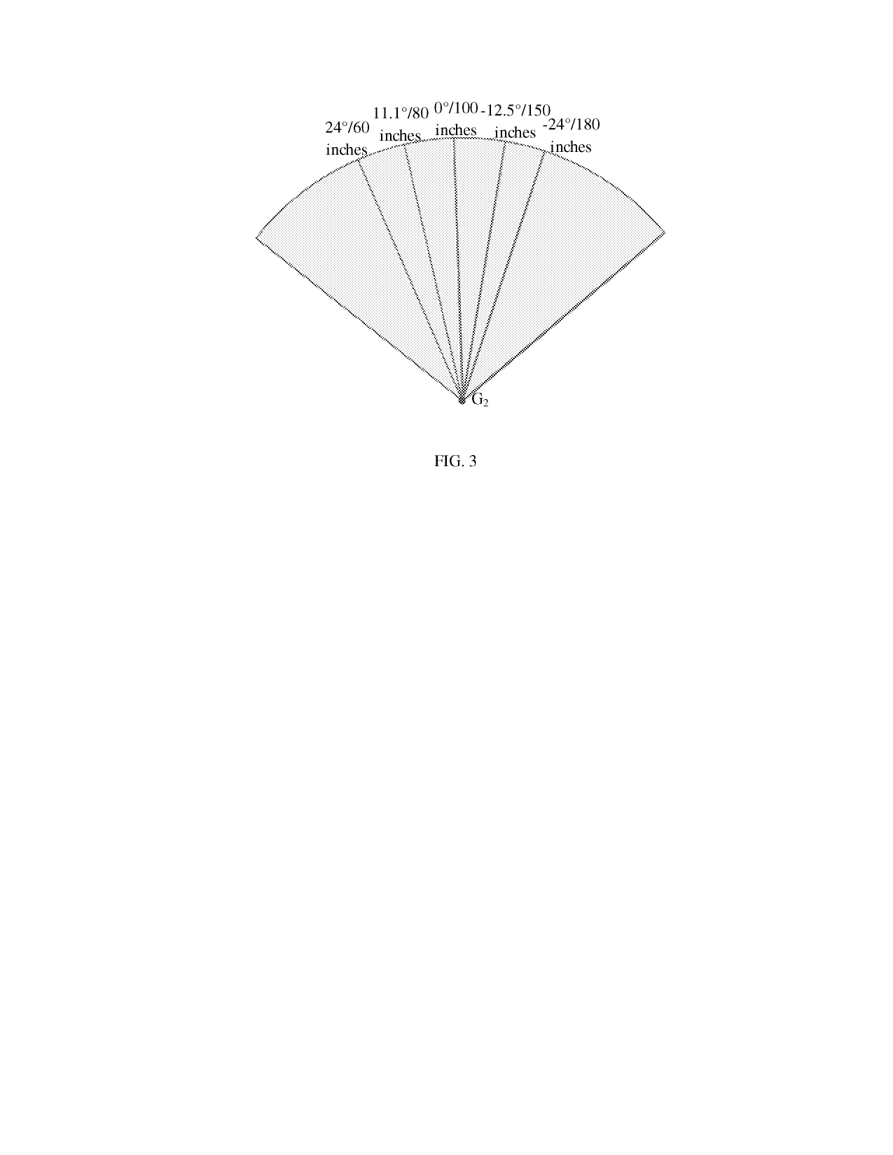

In some embodiment of the present disclosure, the calculating a driving parameter of a focus motor based on the size of the image according to characteristics of the focus motor and the lens module of the projector in the operation S130 may include: calculating the driving parameter of the focus motor based on the size of the image according to a total travel step of the focus motor, a total degree of the lens module, and a corresponding relationship between a degree of the lens module and the size of the image. The calculating the driving parameter of the focus motor based on the size of the image according to a total travel step of the focus motor, a total degree of the lens module, and a corresponding relationship between a degree of the lens module and the size of the image may include: calculating a step required for the focus motor to rotate per one degree conversion of the lens module according to the total travel step of the focus motor and the total degree of the lens module; determining an angle that the lens module is required to convert based on the calculated size of the image according to the corresponding relationship between the degree of the lens module and the size of the image; and calculating a total required travel step of the focus motor based on the step required for the focus motor to rotate per one degree conversion of the lens module and the determined angle that the lens module is required to convert, and taking the total required travel step as the driving parameter. The following description is made in conjunction with FIG. 3.

FIG. 3 shows a schematic diagram of an example of a corresponding relationship between a degree of a lens module and an image size in an auto-focus method for a projector according to some embodiments of the present disclosure. As shown in FIG. 3, as an example, the characteristics of a lens module G2 of the projector may be as follows. The total degrees are 48° including a degree range from -24° to 24°, and each degree corresponds to an image size. In the example shown in FIG. 3, several degrees and corresponding image sizes are exemplarily listed, including: 24°/60 inches, 11.1°/80 inches, 0°/100 inches, -125°/150 inches, and -24°/180 inches. The above data reflect the corresponding relationship between the degree of the lens module and the image size. Here, the unit of the image size is inch. The unit of the projected image size calculated in the aforementioned operation S120 is meter. Therefore, a unit conversion of the image size may be performed first. Then, based on the calculated image size and the aforementioned corresponding relationship between the degree of the lens module and the image size, the angle that the lens module is required to convert corresponding to the image size may be determined.

Then, based on the characteristic of the focus motor—the total travel step, and in combination with the aforementioned total degree of the lens module, the step required for the focus motor to rotate per one degree conversion of the lens module may be calculated. Continuing to refer to FIG. 3, assuming that the total travel steps of the focus motor are 240 steps, and in combination with the aforementioned total degrees of the lens module of 48°, the steps required for the focus motor to rotate per one degree conversion of the lens module may be calculated as 5 steps, i.e., 5 steps/degree. Finally, based on the steps required for the focus motor to rotate per one degree conversion of the lens module (5 steps/degree) and the angle that the lens module is required to convert corresponding to the image size calculated previously, the total required travel step of the focus motor may be obtained, i.e., the driving parameter of the focus motor may be obtained. According to this driving parameter, the focus motor may be controlled to drive the lens module to move, i.e., the focus motor may perform achieving the calculated travel steps, the required angle that the lens module is driven to convert, and the image size corresponding to the angle that overlaps with the image size calculated previously, thereby achieving a fast focus effect, completing in one operation without the need to continuously drive the lens to move to find the contrast point in the image and without the need for a focus image.

In summary, the auto-focus method 100 for the projector of the present disclosure may use a distance measuring component such as a single TOF module to quickly measure the vertical distance between the projector and the projection screen, calculate the size of the actual projected image based on the currently measured distance, and then calculate the actual steps for the motor focus based on the relationship between the actually calculated size and the angle ratio relationship output by the focus motor, thereby achieving the purpose of fast focus.

Based on the above description, the auto-focus method for the projector according to some embodiments of the present disclosure may quickly achieve auto-focus. Since there is no need to pop up a focus image via a camera, the viewing process is not interrupted, thereby improving user experience.

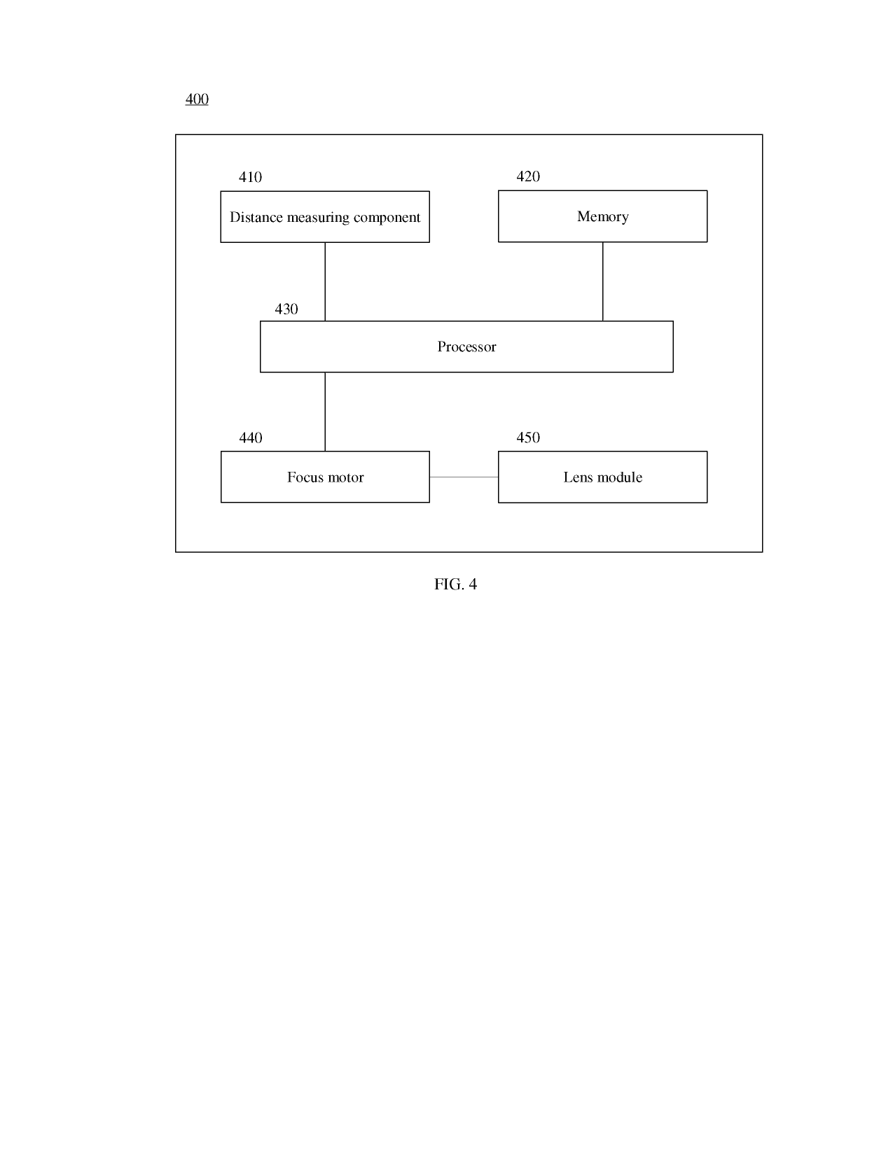

The auto-focus method for the projector according to some embodiments of the present disclosure is exemplarily described above. A projector provided by another aspect of the present disclosure is described below with reference to FIG. 4.

FIG. 4 shows a schematic block diagram of a projector 400 according to some embodiments of the present disclosure. As shown in FIG. 4, the projector 400 according to some embodiment of the present disclosure may include a distance measuring component 410, a memory 420, a processor 430, a focus motor 440, and a lens module 450. The distance measuring component 410 may be configured to output distance measurement data related to a distance between the projector 400 and a projection screen. The memory 420 may be configured to store an executable program. The processor 430 may be configured to execute the program stored in the memory 420 to cause the processor 430 to perform the aforementioned auto-focus method for the projector according to some embodiments of the present disclosure. Those skilled in the art may understand the structure and operations of each component of the projector according to the embodiment of the present disclosure in conjunction with the content described above. For conciseness, details are not repeated here, and only some main operations are described.

In some embodiments of the present disclosure, when a computer program is executed by the processor 430, the processor 430 may be caused to perform the following operations: calculating a projection distance based on the distance measurement data output by the distance measuring component 410; calculating a size of an image projected by the projector based on the projection distance according to a throw ratio of the lens module 450; calculating a driving parameter of the focus motor 440 based on the size of the image according to characteristics of the focus motor 440 and the lens module 450; controlling the focus motor 440 to drive the lens module 450 to move based on the driving parameter of the focus motor 440 to achieve auto-focus.

In some embodiment of the present disclosure, the distance measuring component 410 may include a time-of-flight sensor module.

In some embodiments of the present disclosure, the distance measuring component 410 may include a first time-of-flight sensor and a second time-of-flight sensor. The first time-of-flight sensor may be configured to output a first distance, the first distance may be a distance from a position of the first time-of-flight sensor to a first position on the projection screen. The second time-of-flight sensor may be configured to output a second distance, the second distance is a distance from a position of the second time-of-flight sensor to a second position on the projection screen. The second distance may be greater than the first distance, the second distance minus the first distance equals a third distance, the third distance may be a distance from a third position to the second position, and the third position may be a position between the second time-of-flight sensor and the second position. The calculating, by the processor, the projection distance based on the distance measurement data may include: calculating a distance from the first position to the third position based on the first distance, an angle of the second time-of-flight sensor, and a distance between the first time-of-flight sensor and the second time-of-flight sensor, and taking the distance from the first position to the third position as a fourth distance; calculating a distance from the first position to the second position based on the third distance, the fourth distance, and the angle, and taking the distance from the first position to the second position as a fifth distance; calculating an included angle between a straight line where the fourth distance is located and a straight line where the fifth distance is located based on the third distance, the fourth distance, the fifth distance, and the angle; and calculating the projection distance from the projector to the projection screen based on the first distance, the angle, the included angle, and the distance between the first time-of-flight sensor and the second time-of-flight sensor.

In some embodiments of the present disclosure, the calculating, by the processor 430, the size of the image projected by the projector 400 based on the projection distance according to the throw ratio of the lens module 450 of the projector 400 may include: dividing the projection distance by the throw ratio of the lens module 450, and obtaining a lateral size of the image projected by the projector 400; calculating a longitudinal size of the image projected by the projector 400 based on an aspect ratio of the image projected by the projector 400 and the lateral size; and calculating a diagonal size of the image projected by the projector 400 based on the lateral size and the longitudinal size, and taking the diagonal size as the size of the image.

In some embodiments of the present disclosure, the calculating, by the processor 430, the longitudinal size of the image projected by the projector 400 based on the aspect ratio of the image projected by the projector 400 and the lateral size may include: calculating a product of the lateral size and the aspect ratio, calculating a reciprocal of the product, and obtaining the longitudinal size of the image projected by the projector 400.

In some embodiments of the present disclosure, the calculating, by the processor 430, the diagonal size of the image projected by the projector 400 based on the lateral size and the longitudinal size may include: calculating a square root of a sum of squares of the lateral size and the longitudinal size, and obtaining the diagonal size of the image projected by the projector 400.

In some embodiments of the present disclosure, the calculating, by the processor 430, a driving parameter of the focus motor 440 based on the size of the image according to characteristics of the focus motor 440 and the lens module 450 may include: the calculating driving parameter of the focus motor 440 based on the size of the image according to the total travel step of the focus motor 440, the total degree of the lens module 450, and the corresponding relationship between the degree of the lens module 450 and the size of the image.

In some embodiments of the present disclosure, the calculating, by the processor 430, driving parameter of the focus motor 440 based on the size of the image according to the total travel step of the focus motor 440, the total degree of the lens module 450, and the corresponding relationship between the degree of the lens module 450 and the size of the image may include: calculating a step required for the focus motor 440 to rotate per one degree conversion of the lens module 450 according to the total travel step of the focus motor 440 and the total degree of the lens module 450; determining an angle that the lens module 450 is required to convert based on the calculated size of the image according to the corresponding relationship between the degree of the lens module 450 and the size of the image; and calculating a total required travel step of the focus motor 440 based on the step required for the focus motor 440 to rotate per one degree conversion of the lens module 450 and the determined angle that the lens module 450 is required to convert, and taking the total required travel step as the driving parameter.

Based on the above description, the projector 400 according to some embodiments of the present disclosure may calculate the size of the image projected by the projector onto the projection screen based on the projection distance measured by the distance measuring component and in combination with the throw ratio of the lens module of the projector. Based on this size and in combination with the characteristics (mainly involving the total travel step of the focus motor, the total degree of the lens module, and the corresponding relationship between the degree of the lens module and the size of the image) of the focus motor and the lens module, the driving parameter of the focus motor may be calculated. According to this driving parameter, the lens module may be controlled to move, thereby quickly achieving auto-focus. Moreover, since there is no need to pop up a focus image via a camera, the viewing process is not interrupted, thereby improving user experience.

In addition, according to some embodiments of the present disclosure, a storage medium is provided. A program instruction is stored on the storage medium, and the program instruction is configured to perform corresponding operations of the auto-focus method for the projector according to the embodiments of the present disclosure when the program instruction is executed by a computer or processor. The storage medium may include, for example, a memory card of a smartphone, a storage component of a tablet computer, a hard disk of a personal computer, a read-only memory (ROM), an erasable programmable read-only memory (EPROM), a portable compact disc read-only memory (CD-ROM), a USB memory, or any combination of the above storage media. The computer-readable storage medium may be any combination of one or more computer-readable storage media.

Based on the above description, the auto-focus method for the projector and the projector according to the embodiments of the present disclosure may quickly achieve auto-focus. Moreover, since there is no need to pop up a focus image via a camera, the viewing process is not interrupted, thereby improving user experience.

Although exemplary embodiments have been described herein with reference to the accompanying drawings, it should be understood that the above exemplary embodiments are merely illustrative and are not intended to limit the scope of the present disclosure. Various changes and modifications may be made by those skilled in the art without departing from the scope and spirit of the present disclosure. All such changes and modifications are intended to be included within the scope of the present disclosure as claimed in the appended claims.

Those skilled in the art may understand that the units and algorithm operations of the various examples described in connection with the embodiments disclosed herein may be implemented in an electronic hardware, or a combination of a computer software and an electronic hardware. Whether these functions are performed in hardware or software depends on the particular application and design constraints of the technical solution. Professionals may use different methods for each particular application to implement the described functions, but such implementation should not be considered beyond the scope of the present disclosure.

In some embodiments provided in the present disclosure, it should be understood that the disclosed apparatus and method may be implemented in other ways. For example, the above-described apparatus embodiments are merely illustrative. For example, the division of units is only a logical function division. In actual implementation, there may be other division manners, for example, multiple units or components may be combined or integrated into another apparatus, or some features may be omitted or not executed.

In the specification provided herein, numerous details are described. However, it may be understood that the embodiments of the present disclosure may be practiced without these details. In some embodiments, well-known methods, structures, and techniques have not been shown in detail in order not to obscure the understanding of this specification.

Similarly, it should be understood that, in order to simplify the present disclosure and understand one or more of the various inventive aspects, in the description of the exemplary embodiments of the present disclosure, various features of the present disclosure are sometimes grouped together into a single embodiment, figure, or description thereof. However, the method of the present disclosure should not be interpreted as reflecting an intention that the claimed present disclosure requires more features than those expressly recited in each claim. Rather, as the following claims reflect, inventive aspects lie in less than all features of a single disclosed embodiment to solve the corresponding technical problem. Thus, the claims following the detailed description are hereby expressly incorporated into this detailed description, and each claim serves as a separate embodiment of the present disclosure.

Those skilled in the art may understand that, except where features are mutually exclusive, any combination of all features disclosed in this specification (including the accompanying claims, abstract, and drawings) and all processes or units of any method or apparatus so disclosed may be combined. Unless expressly stated otherwise, each feature disclosed in this specification (including the accompanying claims, abstract, and drawings) may be replaced by an alternative feature serving the same, equivalent, or similar purpose.

Furthermore, those skilled in the art may understand that although some embodiments described herein include certain features included in other embodiments rather than other features, combinations of features of different embodiments mean that they are within the scope of the present disclosure and form different embodiments. For example, in the claims, any one of the claimed embodiments may be used in any combination.

The various component embodiments of the present disclosure may be implemented in a hardware, or in a software module running on one or more processors, or in a combination thereof. Those skilled in the art may understood that a microprocessor or digital signal processor (DSP) may be used in practice to implement some or all of the functions of some modules according to embodiments of the present disclosure. The present disclosure may also be implemented as an apparatus program (e.g., a computer program and a computer program product) for performing some or all of the methods described herein. Such a program implementing the present disclosure may be stored on a computer-readable medium or may be in the form of one or more signals. Such signals may be downloaded from an Internet website, provided on a carrier signal, or provided in any other form.

It should be noted that the above embodiments illustrate the present disclosure but do not limit it, and those skilled in the art will be able to design alternative embodiments without departing from the scope of the appended claims. In the claims, any reference signs placed between parentheses shall not be construed as limiting the claim. The word “comprise” does not exclude the presence of elements or operations not listed in a claim. The word “a” or “an” preceding an element does not exclude the presence of a plurality of such elements. The present disclosure may be implemented by means of a hardware including several distinct elements and by means of a suitably programmed computer. In the unit claims enumerating several components, several of these components may be embodied by one and the same item of a hardware. The use of the words first, second, and third, etc., does not indicate any order. These words are to be interpreted as names.

The above description is only some embodiments of the present disclosure or an explanation of the embodiments. The protection scope of the present disclosure is not limited thereto. Any changes or substitutions that may be easily conceived by those skilled in the art within the technical scope disclosed in the present disclosure shall be covered within the scope of the present disclosure. The scope of the present disclosure shall be subject to the scope of the claims.

1. An auto-focus method for a projector, comprising:
calculating a projection distance based on measurement data from a distance measuring component of the projector;
calculating a size of an image projected by the projector based on the projection distance according to a throw ratio of a lens module of the projector;
calculating a driving parameter of a focus motor based on the size of the image according to characteristics of the focus motor and the lens module of the projector; and
controlling the focus motor to drive the lens module to move based on the driving parameter of the focus motor, and achieving auto-focus.

2. The method according to claim 1, wherein calculating the size of the image projected by the projector based on the projection distance according to the throw ratio of the lens module of the projector, comprises:
dividing the projection distance by the throw ratio of the lens module, and obtaining a lateral size of the image projected by the projector;
calculating a longitudinal size of the image projected by the projector based on an aspect ratio of the image projected by the projector and the lateral size; and
calculating a diagonal size of the image projected by the projector based on the lateral size and the longitudinal size, and taking the diagonal size as the size of the image.

3. The method according to claim 2, wherein calculating the longitudinal size of the image projected by the projector based on the aspect ratio of the image projected by the projector and the lateral size, comprises:
calculating a product of the lateral size and the aspect ratio, calculating a reciprocal of the product, and obtaining the longitudinal size of the image projected by the projector.

4. The method according to claim 2, wherein calculating the diagonal size of the image projected by the projector based on the lateral size and the longitudinal size, comprises:
calculating a square root of a sum of squares of the lateral size and the longitudinal size, and obtaining the diagonal size of the image projected by the projector.

5. The method according to claim 1, wherein calculating the driving parameter of the focus motor based on the size of the image according to the characteristics of the focus motor and the lens module of the projector, comprises:
calculating the driving parameter of the focus motor based on the size of the image according to a total travel step of the focus motor, a total degree of the lens module, and a corresponding relationship between a degree of the lens module and the size of the image.

6. The method according to claim 5, wherein calculating the driving parameter of the focus motor based on the size of the image according to the total travel step of the focus motor, the total degree of the lens module, and the corresponding relationship between the degree of the lens module and the size of the image, comprises:
calculating a step required for the focus motor to rotate per one degree conversion of the lens module according to the total travel step of the focus motor and the total degree of the lens module;
determining an angle that the lens module is required to convert based on the size of the image according to the corresponding relationship between the degree of the lens module and the size of the image; and
calculating a total required travel step of the focus motor based on the step required for the focus motor to rotate per one degree conversion of the lens module and the angle that the lens module is required to convert, and taking the total required travel step of the focus motor as the driving parameter.

7. The method according to claim 1, wherein the distance measuring component comprises a time-of-flight sensor module.

8. The method according to claim 7, wherein the distance measuring component comprises a first time-of-flight sensor and a second time-of-flight sensor, wherein
the first time-of-flight sensor is configured to output a first distance, and the first distance is a distance from a position of the first time-of-flight sensor to a first position on a projection screen;
the second time-of-flight sensor is configured to output a second distance, and the second distance is a distance from a position of the second time-of-flight sensor to a second position on the projection screen;
wherein the second distance is greater than the first distance, the second distance minus the first distance equals a third distance, the third distance is a distance from a third position to the second position, and the third position is a position between the second time-of-flight sensor and the second position;
calculating the projection distance based on the measurement data from the distance measuring component of the projector, comprises:
calculating a distance from the first position to the third position based on the first distance, an angle of the second time-of-flight sensor, and a distance between the first time-of-flight sensor and the second time-of-flight sensor, and taking the distance from the first position to the third position as a fourth distance;
calculating a distance from the first position to the second position based on the third distance, the fourth distance, and the angle, and taking the distance from the first position to the second position as a fifth distance;
calculating an included angle between a straight line where the fourth distance is located and a straight line where the fifth distance is located based on the third distance, the fourth distance, the fifth distance, and the angle; and
calculating the projection distance from the projector to the projection screen based on the first distance, the angle, the included angle, and the distance between the first time-of-flight sensor and the second time-of-flight sensor.

9. A projector, comprising a distance measuring component, a memory, a processor, a focus motor and a lens module, wherein
the distance measuring component is configured to output distance measurement data related to a distance between the projector and a projection screen;
the memory is configured to store an executable program;
the processor is configured to execute the program stored in the memory to cause the processor to perform the following operations:
calculating a projection distance based on the distance measurement data;
calculating a size of an image projected by the projector based on the projection distance according to a throw ratio of the lens module;
calculating a driving parameter of the focus motor based on the size of the image according to characteristics of the focus motor and the lens module; and
controlling the focus motor to drive the lens module to move based on the driving parameter of the focus motor, and achieving auto-focus.

10. The projector according to claim 9, wherein the distance measuring component comprises a time-of-flight sensor module.

11. The projector according to claim 10, wherein the distance measuring component comprises a first time-of-flight sensor and a second time-of-flight sensor, wherein
the first time-of-flight sensor is configured to output a first distance, and the first distance is a distance from a position of the first time-of-flight sensor to a first position on the projection screen;
the second time-of-flight sensor is configured to output a second distance, and the second distance is a distance from a position of the second time-of-flight sensor to a second position on the projection screen;
wherein the second distance is greater than the first distance, the second distance minus the first distance equals a third distance, the third distance is a distance from a third position to the second position, and the third position is a position between the second time-of-flight sensor and the second position;
calculating, by the processor, the projection distance based on the distance measurement data, comprises:
calculating a distance from the first position to the third position based on the first distance, an angle of the second time-of-flight sensor, and a distance between the first time-of-flight sensor and the second time-of-flight sensor, and taking the distance from the first position to the third position as a fourth distance;
calculating a distance from the first position to the second position based on the third distance, the fourth distance, and the angle, and taking the distance from the first position to the second position as a fifth distance;
calculating an included angle between a straight line where the fourth distance is located and a straight line where the fifth distance is located based on the third distance, the fourth distance, the fifth distance, and the angle; and
calculating the projection distance from the projector to the projection screen based on the first distance, the angle, the included angle, and the distance between the first time-of-flight sensor and the second time-of-flight sensor.

12. The projector according to claim 9, wherein calculating, by the processor, the size of the image projected by the projector based on the projection distance according to the throw ratio of the lens module, comprises:
dividing the projection distance by the throw ratio of the lens module, and obtaining a lateral size of the image projected by the projector;
calculating a longitudinal size of the image projected by the projector based on an aspect ratio of the image projected by the projector and the lateral size; and
calculating a diagonal size of the image projected by the projector based on the lateral size and the longitudinal size, and taking the diagonal size as the size of the image.

13. The projector according to claim 12, wherein calculating, by the processor, the longitudinal size of the image projected by the projector based on the aspect ratio of the image projected by the projector and the lateral size, comprises:
calculating a product of the lateral size and the aspect ratio, calculating a reciprocal of the product, and obtaining the longitudinal size of the image projected by the projector.

14. The projector according to claim 12, wherein calculating, by the processor, the diagonal size of the image projected by the projector based on the lateral size and the longitudinal size, comprises:
calculating a square root of a sum of squares of the lateral size and the longitudinal size, and obtaining the diagonal size of the image projected by the projector.

15. The projector according to claim 9, wherein calculating, by the processor, the driving parameter of the focus motor based on the size of the image according to the characteristics of the focus motor and the lens module, comprises:
calculating the driving parameter of the focus motor based on the size of the image according to a total travel step of the focus motor, a total degree of the lens module, and a corresponding relationship between a degree of the lens module and the size of the image.

16. The projector according to claim 15, wherein calculating, by the processor, the driving parameter of the focus motor based on the size of the image according to the total travel step of the focus motor, the total degree of the lens module, and the corresponding relationship between the degree of the lens module and the size of the image, comprises:
calculating a step required for the focus motor to rotate per one degree conversion of the lens module according to the total travel step of the focus motor and the total degree of the lens module;
determining an angle that the lens module is required to convert based on the size of the image according to the corresponding relationship between the degree of the lens module and the size of the image; and
calculating a total required travel step of the focus motor based on the step required for the focus motor to rotate per one degree conversion of the lens module and the angle that the lens module is required to convert, and taking the total required travel step of the focus motor as the driving parameter.

17. A non-transitory computer-readable storage medium storing a program instruction; wherein the program instruction is configured to enable a processor to perform an auto-focus method for a projector; wherein the auto-focus method comprises:
calculating a projection distance based on measurement data from a distance measuring component of the projector;
calculating a size of an image projected by the projector based on the projection distance according to a throw ratio of a lens module of the projector;
calculating a driving parameter of a focus motor based on the size of the image according to characteristics of the focus motor and the lens module of the projector; and
controlling the focus motor to drive the lens module to move based on the driving parameter of the focus motor, and achieving auto-focus.

18. The non-transitory computer-readable storage medium according to claim 17, wherein calculating the size of the image projected by the projector based on the projection distance according to the throw ratio of the lens module of the projector, comprises:
dividing the projection distance by the throw ratio of the lens module, and obtaining a lateral size of the image projected by the projector;
calculating a longitudinal size of the image projected by the projector based on an aspect ratio of the image projected by the projector and the lateral size; and
calculating a diagonal size of the image projected by the projector based on the lateral size and the longitudinal size, and taking the diagonal size as the size of the image.

19. The non-transitory computer-readable storage medium according to claim 18, wherein calculating the longitudinal size of the image projected by the projector based on the aspect ratio of the image projected by the projector and the lateral size, comprises:
calculating a product of the lateral size and the aspect ratio, calculating a reciprocal of the product, and obtaining the longitudinal size of the image projected by the projector.

20. The non-transitory computer-readable storage medium according to claim 18, wherein calculating the diagonal size of the image projected by the projector based on the lateral size and the longitudinal size, comprises:
calculating a square root of a sum of squares of the lateral size and the longitudinal size, and obtaining the diagonal size of the image projected by the projector.
